(19) United States
(12) Patent Application Publication
(10) Pub. No.: US 2025/0256450 A1
(43) Pub. Date: Aug. 14, 2025

(54) EXTRUDER SYSTEM AND METHOD FOR PROCESSING WASHED POLYMER PARTICLES

(71) Applicant: Gneuss GmbH, Bad Oeynhausen (DE)

(72) Inventors: Stephan GNEUSS, Bad Oeynhausen (DE); Detlef GNEUSS, Carabietta (CH); Daniel GNEUSS, Charlotte, NC (US)

(73) Assignee: Gneuss GmbH, Bad Oeynhausen (DE)

(21) Appl. No.: 19/172,546

(22) Filed: Apr. 7, 2025

Related U.S. Application Data
(63) Continuation of application No. PCT/DE2023/100759, filed on Oct. 11, 2023.

(30) Foreign Application Priority Data
Oct. 14, 2022 (DE) 10 2022 127 014.9

(51) Int. Cl. B29C 48/76; B29C 48/29; B29C 48/635; B29C 48/793

(52) U.S. Cl. CPC B29C 48/767; B29C 48/29; B29C 48/635; B29C 48/793

(57) ABSTRACT

An extruder system for processing washed polymer particles, at least comprising an MRS extruder, which has: a housing having an inner housing cavity, the housing cavity extending at least between an inlet opening and an outlet opening and comprising at least one degassing zone; and an extruder screw, which can be rotated in the housing cavity and which has at least one helical extruder screw flight. The extruder screw is divided into: an inlet screw section, into which the inlet opening leads; a multi-screw section, in which a plurality of satellite screws rotate together with a main screw and additionally rotate about their own axis, the diameter of the multi-screw section being larger than the screw diameter of the inlet screw; a transition cone, which is formed between the inlet screw section and the multi-screw section; and an outlet screw section, which has a smaller diameter than the multi-screw section.

This nonprovisional application is a continuation of International Application No. PCT/DE2023/100759, which was filed on Oct. 11, 2023, and which claims priority to German Patent Application No. 10 2022 127 014.9, which was filed in Germany on Oct. 14, 2022, and which are both herein incorporated by reference.

### BACKGROUND OF THE INVENTION

### Field of the Invention

The invention relates to an extruder system for treating washed polymer particles and to a method for treating washed polymer particles.

### Description of the Background Art

An extruder having a multiscrew section in which multiple satellite screws rotate together with a main screw and additionally rotate about their own axis is known, for example, from EP 1 434 680 A1, which corresponds to US 2005/047267, which is incorporated herein by referencee. This type of extruder has proven suitable for treating plastic waste, in particular polyester particles, since it is possible not only to remove foreign substances and perform degassing of the polymer melt, but also to increase the intrinsic viscosity of the polyester melt. The extruder type, referred to as “MRS,” is very well suited for deep degassing, since the plastic particles are processed with minimal shear input, so that the polymer surface in the degassing zone is enlarged, and moisture and other volatile substances may be effectively evacuated.

With the MRS extruder, the degassing must take place at low pressures, in particular for processing polyester, in which in addition to decontamination, the intrinsic viscosity is also to be increased. It is therefore necessary to use vacuum pumps.

Upstream washing units are usually provided for the recycling of plastic waste. In particular for thin film shreds, a thin film of water accounts for a very high proportion of water in relation to the mass of the polymer particles. A high proportion of water in the processed plastic particles, which occurs, for example, in shredded and washed plastic particles from household packaging, results in high gas volumes in the MRS extruder which must be removed from the degassing zone by use of vacuum pumps. The energy-intensive operation of the vacuum pumps makes the use of a conventional MRS extruder uneconomical with high gas fractions, in particular for the processing of washed plastic waste.

A further problem with the conventional art is that a relatively short inlet screw must be used for gentle melting of the polymer. However, for a good degassing effect, a high degree of plasticization of the polymer upon entry into the degassing zone is necessary, which is preferably achieved using longer inlet screws.

Further, the outlet screw section must be operated in synchronization with units that are connected to the extruder system. Therefore, the outlet screw section must have a certain rotational speed, which in turn also specifies the rotational speeds of the connected inlet screw section and multiscrew section. Thus, the rotational speed cannot be varied in the inlet screw section in order to achieve gentle material processing.

### SUMMARY OF THE INVENTION

It is therefore an object of the invention, to optimize an MRS extruder for economical treatment of plastic wastes that develop a high gas load, in particular for the treatment of washed polymer particles.

In an example, the concept of the invention is to connect a cutter compactor directly to the inlet stage of an MRS extruder, and to specify particular geometric relationships for the screws in the MRS extruder. The cutter compactor allows water separation, which is important for washed recycling material, for example, in order to relieve load on the MRS extruder, and enables preplasticization.

Due to the combination of an MRS extruder with a cutter compactor connected upstream from the inlet screw, the polymer material to be processed can already be plasticized before entry into the extruder. Use of the cutter compactor thus already provides a certain degree of plasticization for the extruder treatment, so that during the subsequent treatment in the MRS extruder it is no longer necessary for the entire plasticization to take place, but, rather, only for the degree of plasticization to be increased. For this purpose, it is provided that the multiscrew section contains four to eight satellite screws whose length in each case is at least four times the diameter. It is thus possible to use a relatively short inlet screw section having a diameter-to-length ratio less than or equal to 1:22, in particular less than or equal to 1:16, which allows appropriately gentle further processing of the polymer in the MRS extruder.

According to an example, the geometry of the extruder screw of the MRS extruder which is optimized according to the invention provides that the following relationship applies for the diameter D_{S} of the cutting container and the diameter D_{M} of the multiscrew section:

$${D}_{M} \geq 0.2 * {D}_{S} - 85 mm * GF ,$$

where GF is an empirically determined size factor and GF≥0.8. As a result of this ratio, the degassing performance of the MRS extruder is cost-effectively matched to the degassing performance of the cutter compactor, and the degassing of the MRS extruder is determined only by the deep degassing, but not by the surface moisture. This allows construction of efficient vacuum units.

The size of the minimum diameter of the multiscrew section indicates the size for which appreciable deep degassing can take place at all. If the diameter is smaller, on the one hand insufficient surface is available, and on the other hand the filling rate during operation is too high, so that excessively thick layers form in the MRS which are difficult to adequately degas, i.e., due to excessive effort for generating and maintaining the vacuum.

A diameter that is larger than defined by the stated relationship as a boundary condition is possible, for example to even further improve the decontamination performance. However, the diameter of the multiscrew section is preferably selected to be no greater than 0.28 times the cutter compactor diameter minus 100 mm, since otherwise the shear input for the MRS extruder becomes too high.

In the combination proposed by the invention, it is thus important to perform the material pretreatment in the cutter compactor in such a way that optimal use may be made of the power of the MRS extruder during the deep degassing, while at the same time striving for treatment of washed polymer particles that is gentle on materials and optimized for energy.

Due to selecting the degree of preplasticization in the cutter compactor, which results from a suitable blade rotational speed in the cutting container, the degree of plasticization that is later achievable in the MRS extruder may be controlled without having to exchange the extruder screw or change the rotational speeds of the extruder. The mechanical work of the rotating blade results in heating of the polymer particles present in the cutting container.

A particularly significant effect of combining a cutter compactor with the inlet stage of the MRS extruder is that the material to be processed, while it is still in the cutter compactor, can be heated to temperatures in the range of the boiling point of water, typically to 100° C. to 200° C., at the internal pressure prevailing in the cutting container, so that water and other low-boiling substances evaporate while in the cutter compactor. Since water can thus be removed to a great extent in advance, in particular the surface moisture of the polymer particles, which constitutes a majority of the total gas load in the conventional process that operates using an MRS extruder as described above, is reduced. According to the invention, the portion of the moisture that accounts for adherence of water at the surface for the most part no longer enters the degassing region of the MRS extruder.

Therefore, the upstream connection according to the invention of a cutter compactor while at the same time using a short inlet screw of the MRS extruder is more advantageous than likewise conceivable double degassing in the MRS extruder, in which initially, in a first stage at a relatively high pressure, large volumes must be evacuated by suction, and only in a second stage would it be possible to apply a high vacuum with a low residual pressure in order to remove gas fractions still contained in the polymer melt. However, with such double degassing in the MRS extruder the necessary residence time, at the same time with high shear and temperature, would be too great, so that the quality of the recycled polymer would be impaired.

Use of a cutter compactor in combination with a geometrically matched MRS extruder results in the following further advantages: the cutter compactor increases the density of the material to be drawn in by the MRS extruder and pushes it into the inlet screw section; and the cutter compactor preheats the material, so that in comparison to the remainder of the MRS process, less melting energy now needs to be supplied to the MRS extruder.

In the combination, the result is that: PET materials having a low bulk density of <250 g/L up to ˜50 g/L, for example, are now processable for the first time in the MRS extruder; and the MRS extruder is also usable for other plastics, in particular polyolefins such as PP and PE with low bulk densities, as is typical in the packaging industry due to shapes and layer thicknesses.

In an extruder system according to the invention, evaporation of water from the cutting container at ambient pressure can bring about a significant improvement in the overall process. An additional suction device such as a fan or a vacuum pump may advantageously be provided at the cutter compactor to allow the gas load to be removed from the cutting container more quickly and completely.

A method for treating washed polymer particles is set forth in claim 7. The treatment steps corresponding to a normal process in the MRS extruder are as follows: transferring the quantity of polymer particles into the inlet screw section of the MRS extruder; further leading the polymer, to be plasticized to form a thermoplastic melt, into the multiscrew section; evacuating volatile foreign substances from the melt in the degassing zone; and discharging the degassed melt via the outlet screw section.

The pretreatment process in a cutter compactor prior to the transfer to the MRS extruder comprises the steps: feeding washed polymer particles into the cutting container; and heating the quantity of polymer particles in the cutting container, using at least one rotating blade, to a temperature that is higher than the boiling point of water at the internal pressure prevailing in the cutting container and is lower than the melting point of the polymer, for a period of generally at least 10 minutes, wherein the polymer particles are not only heated, but also comminuted and intermixed by the at least one blade that rotates in the cutting container.

The pressure in a cutting container that is closed off from the surroundings is preferably lowered using a separate suction unit, various types of which may be used.

The pressure in the degassing zone of the MRS extruder is preferably selected to be lower, at least by a factor of 10, than the pressure in the cutting container.

It is also possible, for example, to keep the pressure in the cutting container at ambient pressure, which means either that sufficiently large openings are present at the cutting container, or by use of the separate suction unit an appropriate volume flow is withdrawn so that a pressure increase does not occur, despite the materials evaporating in the cutting container. At the same time, a pressure of 100 mbar or less is maintained in the degassing zone of the MRS extruder.

The pressure may be regulated by adapting the gap width between the extruder screw and the housing borehole, the gap width being influenced by axially shifting the extruder screw with respect to the housing 11. The relevant gap is formed between the housing and the transition cone, which is provided between the inlet screw section and the multiscrew section.

By use of a water ring pump at the MRS extruder, the pressure in the degassing zone may be lowered to approximately 30 mbar while atmospheric pressure is maintained in the cutting container.

In particular, for optimal removal of foreign substances and contaminants from the polymer melt, the pressure in the degassing zone of the MRS extruder may even be less than 10 mbar, and the pressure in the cutting container may be less than 100 mbar. In this way, surface water fractions and other volatile, low-boiling substances that adhere to the polymer particles are already removed in the cutting container, and in the MRS extruder only so-called deep degassing takes place, in which the remaining volatile components are removed from the polymer melt by multiple operations of mixing the polymer in the multiscrew section and a resulting surface enlargement.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole FIGURE illustrates an extruder system according to an example of the invention.

### DETAILED DESCRIPTION

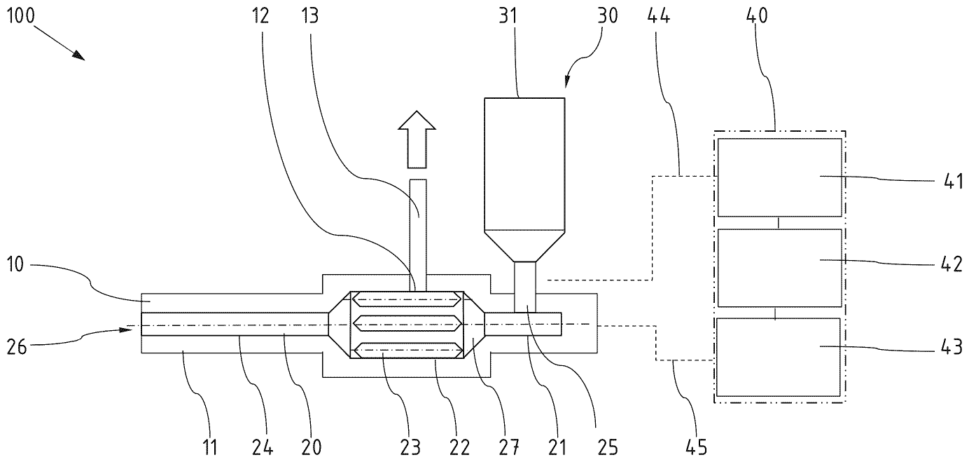

An extruder system 100 for treating washed polymer particles, designed according to the invention, is schematically illustrated in FIG. 1. The extruder system 100 includes an MRS extruder 10 with a housing 11 having an inner housing recess that extends at least between an inlet opening 25 and an outlet opening 26. In a degassing zone the extruder system has a housing opening 12 to which a vacuum suction line 13 of a suction unit is attached. An extruder screw 20 having at least one helical extruder screw flight rotates in the housing recess. The extruder screw 20 is divided into: an inlet screw section 21, designed as a single screw, into which the inlet opening 25 leads; a multiscrew section 22, in which multiple satellite screws 23 rotate together with a main screw and additionally rotate about their own axis, the diameter of the multiscrew section 22 being larger than the screw diameter of the inlet screw 21; a transition cone 27 that is formed between the inlet screw section 21 and the multiscrew section 22; and an outlet screw section 24 that is likewise designed as a single screw and has a smaller diameter than the multiscrew section 22; and a transition cone 28 that is formed between the multiscrew section 22 and the outlet screw section 24.

Mounted on the MRS extruder 10 is a cutter compactor 30 having a blade device with at least one blade that rotates in a cutting container 31. An outlet opening of the cutting container 31 is connected to the inlet opening 25 of the MRS extruder 10.

A cutter compactor control module 41 for the cutter compactor 30 is provided in a machine controller 40, for example for controlling or regulating the blade rotational speed and the pressure and optionally further parameters that are relevant for the cutter compactor 30. An MRS control module 43 for the MRS extruder 10 is also provided therein for controlling or regulating in particular the rotational speed of the extruder screw 20 and the temperature in various temperature zones. Pressure regulation may also be provided, which takes place by adapting the gap width between the transition cone 27 of the extruder screw 20 and the housing recess, the gap width being adjustable by axially shifting the extruder screw 20 with respect to the housing 11.

In addition, a coupling module 42 is provided for synchronizing the operation of the cutter compactor 30 and of the MRS extruder 10 in such a way that the cutter compactor 30 does not operate when empty and also is not completely filled up, and at the same time the MRS extruder 10 is kept at the operating point that is necessary in particular for maintaining the processes downstream from the extruder system 100.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An extruder system for treating washed polymer particles, the extruder system comprising:
an MRS extruder with a housing having an inner housing recess that extends at least between an inlet opening and an outlet opening, and having at least one degassing zone and an extruder screw, with at least one helical extruder screw flight that is rotatable in the housing recess, the extruder screw being divided into:
an inlet screw section into which the inlet opening leads;
a multiscrew section in which multiple satellite screws rotate together with a main screw and additionally rotate about their own axis, a diameter of the multiscrew section being larger than a screw diameter of the inlet screw section;
a transition cone that is formed between the inlet screw section and the multiscrew section;
an outlet screw section that has a smaller diameter than the multiscrew section; and
a cutter compactor that at least includes a cutting container that has an outlet opening connected to the inlet opening of the MRS extruder, and has a blade with at least one blade that rotates in the cutting container,
wherein a diameter-to-length ratio of the inlet screw section is less than 1:22, and
wherein the multiscrew section contains four to eight satellite screws whose length in each case is at least four times its diameter.

2. The extruder system according to claim 1, wherein a diameter-to-length ratio of the inlet screw section is less than or equal to 1:16.

3. The extruder system according to claim 1, wherein the following relationship applies for a diameter D_{S} of the cutting container and a diameter D_{M} of the multiscrew section:
$${D}_{M} \geq ( 0.2 * {D}_{S} - 85 mm ) * GF ,$$
where GF is an empirical size factor and GF≥0.8.

4. The extruder system according to claim 3, wherein the size factor GF≥0.9.

5. The extruder system according to claim 2, wherein D_{M}≤0.28*D_{S}−100 mm.

6. The extruder system according to claim 1, wherein the housing in the at least one degassing zone has at least one housing opening to which a vacuum suction line of a suction unit is connected.

7. The extruder system according to claim 1, wherein the cutting container is closed, and a second suction unit is connected thereto.

8. A method for operating an extruder system according to claim 1, the method comprising:
feeding washed polymer particles into the cutting container;
heating the quantity of polymer particles in the cutting container to a temperature that is higher than a boiling point of water at an internal pressure prevailing in the cutting container and is lower than a melting point of the polymer, the polymer particles being comminuted and intermixed by at least one blade that rotates in the cutting container;
transferring the quantity of polymer particles into the inlet screw section of the MRS extruder;
further leading the polymer, to be plasticized to form a thermoplastic melt, into the multiscrew section;
evacuating volatile foreign substances from the melt in the degassing zone; and
discharging the degassed melt via the outlet screw section.

9. The method according to 8, wherein a cutter compactor with a suction unit is used.

10. The method according to 8, wherein the pressure in the degassing zone of the MRS extruder is selected to be lower, at least by a factor of 10, than the pressure in the cutting container.

11. The method according to 8, wherein the pressure in the degassing zone of the MRS extruder is less than 10 mbar, and the pressure in the cutting container is less than 100 mbar.

12. The method according to 8, wherein the quantity of polymer particles in the cutting container is heated for a period of at least 10 min to a temperature that is higher than the boiling point of water at the internal pressure prevailing in the cutting container and is lower than the melting point of the polymer.
